(19) United States
(12) Patent Application Publication
(10) Pub. No.: US 2026/0257417 A1
(43) Pub. Date: Sep. 3, 2026

(54) SYSTEM, METHOD AND COMPUTER-ACCESSIBLE MEDIUM FACILITATING BIOCHIP FINGERPRINTS FOR AUTHENTICATION

(71) Applicants: NEW YORK UNIVERSITY IN ABU DHABI CORPORATION, Abu Dhabi (AE); ARIZONA BOARD OF REGENTS ON BEHALF OF ARIZONA STATE UNIVERSITY, SCOTTSDALE, AZ (US); NEW YORK UNIVERSITY, New York, NY (US)

(72) Inventors: NAVAJIT SINGH BABAN, Abu Dhabi (AE); RAMESH KARRI, New York, NY (US); KRISHNENDU CHAKRABARTY, SCOTTSDALE, AZ (US); VIJAYAVENKATARAMAN SANJAIRAJ, Abu Dhabi (AE); YONG-AK SONG, Abu Dhabi (AE)

(21) Appl. No.: 19/650,702

(22) Filed: Apr. 17, 2026

Related U.S. Application Data
(63) Continuation of application No. PCT/US2024/051942, filed on Oct. 18, 2024.
(60) Provisional application No. 63/544,685, filed on Oct. 18, 2023.

(51) Int. Cl. B29C 64/118; B33Y 10/00; B33Y 40/20

(52) U.S. Cl. CPC B29C 64/118; B33Y 10/00; B33Y 40/20

(57) ABSTRACT

Exemplary systems and methods according to the exemplary embodiments of the present disclosure are provided for printing a fingerprint. Thus, the exemplary systems and methods can apply, via a melt electrospinning three-dimensional (3D) printer, a filament to a substrate, the substrate interacting randomly with the substrate due to attraction to one or more electrodes.

### CROSS REFERENCE TO RELATED APPLICATIONS

This application relates to and claims the benefit of priority from U.S. Provisional Patent Application No. 63/544,685, filed on Oct. 18, 2023, the entire disclosure of which is incorporated herein by reference.

### STATEMENT REGARDING FEDERALLY FUNDED RESEARCH

This invention was made with government support under the Grant Nos. 2049311, 2049335, and 1833624, awarded by the National Science Foundation. The government has certain rights in the invention.

### FIELD OF THE DISCLOSURE

The present disclosure relates to biochips and printing fingerprints for biochips for authentication purposes, and more particularly to systems, methods and computer-accessible medium facilitating biochip fingerprints for authentication.

### BACKGROUND INFORMATION

Microfluidics is an interdisciplinary field that focuses on manipulating fluids at very small volumes, typically microliters or nanoliters. (See, e.g., Ref. 1). A microfluidic biochip, also known as a lab-on-a-chip, combines various biochemical functionalities into a single miniaturized device, mimicking the capabilities of a laboratory. (See, e.g., Ref. 2). Compared to traditional bench-top laboratories, biochips excel in dispensing, mixing, splitting, and transportation, thanks to the small sample sizes involved. (See, e.g., Ref. 3). The biochips have revolutionized biological computing in numerous areas, including enzymatic, DNA, and proteomic analysis, genetic and polymerase chain reaction (PCR) studies, surface immunoassays, and toxicity monitoring. (See, e.g., Ref. 3). By 2029, it is projected that the biochip market will grow from an estimated value of $19.08 billion in 2024 to a substantial $31.04 billion, with North America identified as the largest market driving this growth. (See, e.g., Ref. 4). However, as with most emerging technologies, innovation takes precedence while security often becomes a secondary consideration, only addressed after vulnerabilities are identified. For example, it has been reported that a staggering 40 million worth of counterfeit or substandard COVID test kits has been confiscated in 77 countries, with 407 individuals arrested during operations conducted between December 2019 and June 2020. (See, e.g., Ref. 5).

Biochip companies have been adopting horizontal supply-chain models to achieve economies of scale and cost reduction. (See, e.g., Refs. 2, 6). Involving untrusted third parties in the supply-chain poses a risk of intellectual property (IP)-based attacks, which include reverse engineering, counterfeiting, and overbuilding. (See, e.g., Refs. 2, 6).

### Exemplary IP-Based Threats On Biochips

The manufacturing process of biochips has several stages and various entities, some of which may be untrustworthy. This can result in IP theft through reverse engineering. By reverse engineering a biochip, an attacker can access valuable information such as its architecture, materials, functions, and bioprotocol. (See, e.g., Ref. 3). Adversaries can use this information to engage in IP piracy, counterfeiting, and over production of biochips. Counterfeit or overbuilt biochips lacking identification taggants can easily infiltrate the supply chain, as the absence of tag-based authentication enables straightforward IP-theft attacks. However, when biochips are equipped with security tags such as watermarks, fingerprints, or quick response (QR) codes, attackers attempt to forge or clone these tags. This may involve brute force tactics or exploiting tag-generating parameters to deceive the trusted third party (TTP) authentication system.

### Exemplary Prior Work On IP Protection Of Biochips

Protecting biochips from IP-based attacks has focused on watermarking [2] and obfuscation. (See, e.g., Ref. 7). Baban et al. proposed a watermarking scheme for FMBs, by increasing the height of micro reaction chambers or micro channels at specific positions to create fluorescent watermarks that can be measured using fluorescence microscopy A previous study uses molecular bar codes at the bioprotocol-level to safeguard the biochemical sample IP. (See, e.g., Ref. 8). The scheme hierarchically embeds secret signatures, using mixing ratio, incubation time, and sensor calibration, in order to protect the bio-samples. Thus far, no work has been done to secure biochips against IP-based threats via fingerprint authentication. This work provides a biochip-level scheme that produces unclonable fingerprints.

Thus, it may be beneficial to provide an exemplary system and method for a device-level fingerprinting scheme, Bio-FP, to authenticate biochips which can overcome at least some of the deficiencies described herein above.

### SUMMARY OF EXEMPLARY EMBODIMENTS

The following is intended to be a brief summary of the exemplary embodiments of the present disclosure and is not intended to limit the scope of the exemplary embodiments.

According to the exemplary embodiments of the present disclosure, methods can be provided for printing fingerprints by applying, via a melt electrospinning 3D printer, a filament to a substrate, said filament interacting randomly/stochastically with the substrate due to attraction to one or more electrodes under an applied electric field. For example, the applied electric field can be 8.0 kV. A thermoplastic polymer, such as, e.g., polycaprolactone (PCL), can be applied to the substrate and over the applied filament. According to some exemplary embodiments of the present disclosure, the filament can include an ultra-violet dye or otherwise be doped with quantum dots.

Further, the exemplary systems can be provided for printing fingerprints, for which a melt electrospinning printer configured to apply a filament to a substrate can be provided. The filament can interact randomly/stochastically with the substrate due to attraction to one or more electrodes under an electric field. For example, the applied electric field can be 8.0 kV. A spin coater configured to uniformly apply an elastomer, such as polydimethylsiloxane (PDMS), to the substrate over the applied filament can be provided. An elastomer can be applied to the substrate and over the applied filament. According to some exemplary embodiments of the present disclosure, the filament can include an ultra-violet dye or otherwise be doped with quantum dots.

In both the exemplary systems and methods, the 3D printer can apply the filament in a defined pattern. Also, the 3D printer can operate under a defined set of print conditions including a temperature of 85° C., a distance of 6 mm between a printer nozzle and the substrate, and a 0.125 MPa dispensing pressure.

These and other objects, features and advantages of the exemplary embodiments of the present disclosure will become apparent upon reading the following detailed description of the exemplary embodiments of the present disclosure, when taken in conjunction with the accompanying claims.

### BRIEF DESCRIPTION OF THE DRAWINGS

Further objects, features and advantages of the present disclosure will become apparent from the following detailed description taken in conjunction with the accompanying Figures showing illustrative embodiments of the present disclosure, in which:

FIG. 1 is an exemplary threat and authentication model for biochip fingerprinting according to an exemplary embodiment of the present disclosure;

FIG. 2(a) is an exemplary melt-electrospinning 3D printer showing the Bio-FP according to an exemplary embodiment of the present disclosure;

FIG. 2(b) is six exemplary Bio-FPs using the same process parameters, illustrating a stochastic nature of the exemplary process in generating unique fingerprint patterns according to an exemplary embodiment of the present disclosure;

FIG. 2(c) is an example of symbols “NYU” printed by a 3D printer before spin coating with PDMS according to an exemplary embodiment of the present disclosure;

FIG. 2(d) is the example of symbols “NYU” obfuscated after spin coating with PDMS according to an exemplary embodiment of the present disclosure;

FIG. 2(e) is an exemplary schematic diagram showing a schematic illustration of a 30 mm diameter circular PDMS layer with ten 1 mm circles, serving as a template for Bio-FP printing according to an exemplary embodiment of the present disclosure;

FIG. 2(f) is an exemplary printing of the schematic diagram of FIG. 2(e) before spin coating with PDMS, illustrating the stochastic nature of the exemplary process according to an exemplary embodiment of the present disclosure;

FIG. 2(g) is an exemplary printing of the schematic illustration of FIG. 2(e) after spin coating with PDMS, showing the obfuscated Bio-FPs in visible light according to an exemplary embodiment of the present disclosure;

FIG. 2(h) is an exemplary printing of the schematic illustration of FIG. 2(e) after spin coating with PDMS in UV light according to an exemplary embodiment of the present disclosure;

FIG. 3(a) is an exemplary quantile-quantile (Q-Q) plot for n_vgg according to an exemplary embodiment of the present disclosure;

FIG. 3(b) is an exemplary quantile-quantile (Q-Q) plot for n_gray according to an exemplary embodiment of the present disclosure;

FIG. 3(c) is an exemplary scatter plot and regression analysis for n_vgg and n_gray according to an exemplary embodiment of the present disclosure;

FIG. 3(d) is an exemplary graph showing mean and standard deviation for n_vgg and n_gray values according to an exemplary embodiment of the present disclosure;

FIG. 4(a) is an exemplary image and preprocessing of the exemplary image according to an exemplary embodiment of the present disclosure;

FIG. 4(b) is an exemplary DL classifier using transfer learning to classify authentic and fake Bio-FPs according to an exemplary embodiment of the present disclosure;

FIG. 4(c) is an exemplary graph showing exemplary results of DL models without and with transfer learning according to an exemplary embodiment of the present disclosure;

FIG. 5 is an illustration of an exemplary block diagram of an exemplary system in accordance with certain exemplary embodiments of the present disclosure; and

FIG. 6 is a set of exemplary bar graphs showing exemplary performance metrics of the supervised binary classification between authentic and counterfeit fingerprints according to an exemplary embodiment of the present disclosure.

Throughout the drawings, the same reference numerals and characters, unless otherwise stated, are used to denote like features, elements, components or portions of the illustrated embodiments. Moreover, while the present disclosure will now be described in detail with reference to the figures, it is done so in connection with the illustrative embodiments and is not limited by the particular embodiments illustrated in the figures and the appended claims.

### DETAILED DESCRIPTION OF EXEMPLARY EMBODIMENTS

The following description of exemplary embodiments provides non-limiting representative examples referencing numerals to particularly describe features and teachings of different exemplary aspects and exemplary embodiments of the present disclosure. The exemplary embodiments described should be recognized as capable of implementation separately, or in combination, with other exemplary embodiments from the description of the exemplary embodiments. A person of ordinary skill in the art reviewing the description of the exemplary embodiments should be able to learn and understand the different described aspects of the present disclosure. The description of the exemplary embodiments should facilitate understanding of the exemplary embodiments of the present disclosure to such an extent that other implementations, not specifically covered but within the knowledge of a person of skill in the art having read the description of embodiments, would be understood to be consistent with an application of the exemplary embodiments of the present disclosure.

Microfluidic biochips are widely used in biological computing, clinical diagnostics, and point-of-care tests. However, the growing demand and the complex supply chain of biochips expose them to intellectual property (IP) attacks such as counterfeiting, overbuilding, and piracy. To address this issue, the exemplary systems, methods and computer-accessible medium according to the exemplary embodiments of the present disclosure can provide a biochip-level fingerprinting (Bio-FP) scheme. The exemplary systems, methods and computer-accessible medium according to the exemplary embodiments of the present disclosure can utilize melt-electrospinning 3D printing techniques to print unique Bio-FPs directly onto biochips. The exemplary systems, methods and computer-accessible medium according to the exemplary embodiments of the present disclosure can also apply a layer of polydimethylsiloxane (PDMS) through spin-coating to obfuscate the Bio-FPs.

Exemplary systems, methods and computer-accessible medium according to the exemplary embodiments of the present disclosure can further be used to dope the Bio-FPs with a fluorescent dye that can be detected by shining UV light. An exemplary authentication of dyed Bio-FPs can be achieved by exemplary systems, methods and computer-accessible medium according to the exemplary embodiments of the present disclosure through spectral analysis by mapping the intensity-wavelength response. To optimize the authentication scheme for Bio-FPs, one or more pre-processing techniques can be employed by the exemplary systems, methods and computer-accessible medium according to the exemplary embodiments of the present disclosure to enhance their quality. Additionally, transfer learning and finetuning, e.g., can be utilized with multiple deep learning models, yielding a high Bio-FP classification accuracy (e.g., about 95.8%).

With the exemplary systems, methods and computer-accessible medium according to the exemplary embodiments of the present disclosure, each biochip can be marked with a unique fingerprint using a melt-electrospinning 3D printer. These fingerprints can be obfuscated with a spin-coated layer of polydimethylsiloxane (PDMS). By doping the printer's ink with a fluorescent dye or quantum dots, the exemplary systems, methods and computer-accessible medium according to the exemplary embodiments of the present disclosure can generate fingerprints that can be identified when exposed to UV light. An exemplary spectral analysis of the fingerprints, according to exemplary embodiments, can provide a unique intensity-wavelength response spectral mapping.

The exemplary systems, methods and computer-accessible medium according to the exemplary embodiments of the present disclosure can provide and/or utilize two or more layers of authentication, e.g., the obfuscated fingerprint image and its unique spectral response. The exemplary systems, methods and computer-accessible medium according to the exemplary embodiments of the present disclosure can utilize deep learning (DL) procedures tailored to distinguish authentic and counterfeit fingerprints. Leveraging transfer learning with pre-trained models, according to the exemplary embodiments of the present disclosure, it is possible to ensure robust and accurate authentication. Exemplary validation and training on the Bio-FP dataset, with the exemplary systems, methods and computer-accessible medium according to the exemplary embodiments of the present disclosure, can provide procedures with high accuracy (e.g., about 99.94%), offering a reliable solution for a biochip authentication.

### Exemplary Biochip Fingerprinting (Bio-FP) Solution

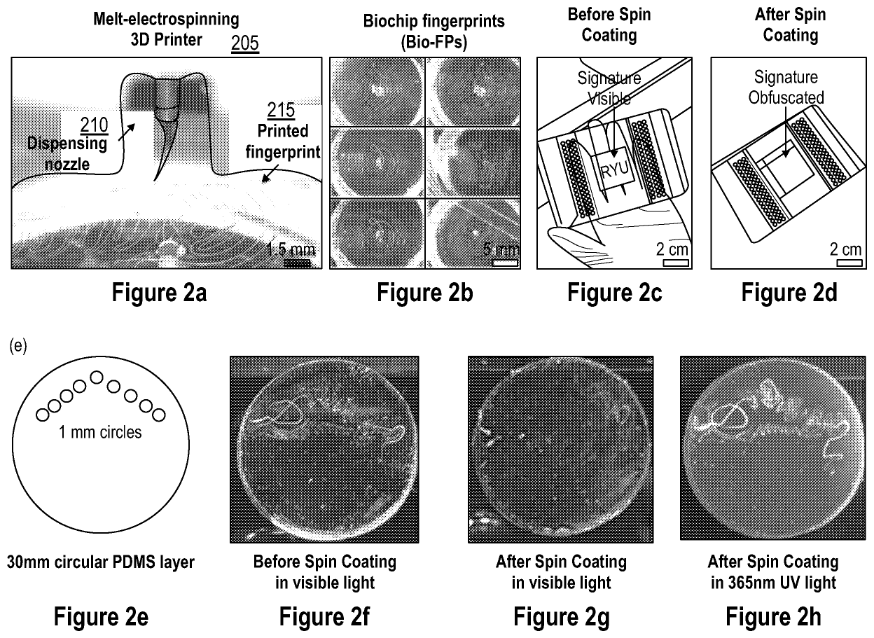

The exemplary systems, methods and computer-accessible medium according to the exemplary embodiments of the present disclosure can be provided which can embed unique fingerprints on biochips that vary from device to device. FIG. 2(a) shows an exemplary melt-electrospinning setup (see, e.g., RegenHu Discovery 3D printer), to create a fingerprint according to exemplary embodiment. The exemplary configuration can include, e.g., melt-electrospinning 3D printer 205 having dispensing nozzle 210. The printer 205 and nozzle 210 may be used to create printed fingerprint 215. Polycaprolactone (PCL) pellets with a molecular weight of 45,000 can be used. The print conditions in exemplary embodiments can include a temperature of 85° C., a distance of 6 mm between needle and substrate, 0.125 MPa pressure, and 8.0 kV voltage. With the exemplary systems, methods and computer-accessible medium according to the exemplary embodiments of the present disclosure, these parameters can form random spiral fibers from a Taylor cone for the fingerprints. In the exemplary embodiments of the present disclosure, upon achieving a stable spiral fiber, the print head can be moved to a specified position and discharged for 5 seconds. (See, e.g., Ref. 9). This can be repeated at each position, while the Bio-FP is printed uniquely.

### Exemplary Bio-FP Process

FIG. 2(b) shows six exemplary fingerprints according to the exemplary embodiments of the present disclosure that were individually printed on PDMS circular samples using the exemplary described process parameters. Each exemplary fingerprint can display subtle variations in its structural design or signature compared to the other exemplary fingerprints. FIG. 2(c) shows an example of the letters “NYU” printed using a 3D printer. FIG. 2(d) shows the same “NYU” illustration printed using a 3D printer obfuscated by spin coating a layer of PDMS, highlighting the exemplary obfuscation scheme to conceal Bio-FP for enhanced security against forging or reverse engineering.

By integrating a fluorescent perylene dye into the ink (PCL) of the melt-electrospinning 3D printer, the fingerprints of exemplary systems, methods and computer-accessible medium according to the exemplary embodiments of the present disclosure can be made fluorescent, rendering them distinctly visible under UV light. FIG. 2(e) shows an exemplary schematic illustration with ten 1 mm circles on a 30 mm diameter circle used as an input for the 3D printer to print. FIG. 2(f) shows the resulting random pattern when exemplary schematic illustration of FIG. 2(e) is printed using the melt-electrospinning 3D printer with the exemplary systems, methods and computer-accessible medium according to the exemplary embodiments of the present disclosure. The mismatch between the ten circles and the printed fingerprint indicates a degree of stochasticity associated with the process. Indeed, e.g., it is unlikely for an attacker to be able to reverse engineer the input print commands from the printed fingerprint.

Furthermore, to obfuscate the fingerprint, the exemplary systems, methods and computer-accessible medium according to the exemplary embodiments of the present disclosure can coat a layer of PDMS. FIG. 2(g) illustrates an example of a layer of PDMS obfuscating the printing of the exemplary schematic of FIG. 2(e). Further, with the exemplary systems, methods and computer-accessible medium according to the exemplary embodiments of the present disclosure, the sample can be exposed to a 365 nm UV light to read the fingerprint. FIG. 2(h) shows the obfuscated printing of the exemplary schematic illustration of FIG. 2(e) under 365 nm UV light, thereby rendering the obfuscated printing visible.

The exemplary systems, methods and computer-accessible medium according to the exemplary embodiments of the present disclosure can implement deep learning (DL)-based verifiers to distinguish between authentic and fake fingerprints'images. DL models of exemplary embodiments of the present disclosure can be trained, for example in one embodiment, using authentic and fake fingerprints (e.g., 437 and 253 respectively), which can be printed on glass slides at equal intervals. The authentic fingerprints can be printed in a single or multiple session with the specified process parameters. In contrast, the exemplary systems, methods and computer-accessible medium according to the exemplary embodiments of the present disclosure can create fake fingerprints by applying a different voltage in an effort to forge via brute-force, as well as by using the same process parameters on different machines and/or at different times.

### Exemplary Bio-FP Analysis

To classify the distribution of Bio-FPs as random fingerprints, the exemplary systems, methods and computer-accessible medium according to the exemplary embodiments of the present disclosure can examine whether the distribution adheres to a normal distribution. The exemplary systems, methods and computer-accessible medium according to the exemplary embodiments of the present disclosure can obtain unique single-point values from the Bio-FP images using two techniques. First, the exemplary embodiments can obtain a single-point value representation from an image using the VGG16 (vgg) (see, e.g., Ref. 10) ML model by applying global average pooling to the output feature maps. These averaged values can be concatenated to create a compact and representative feature vector that captures the essential image characteristics. Additionally, the exemplary embodiments can convert the images to grayscale (gray) to ensure a single-channel representation and compute the average intensity by summing the intensities of all pixels and dividing the sum by the number of pixels.

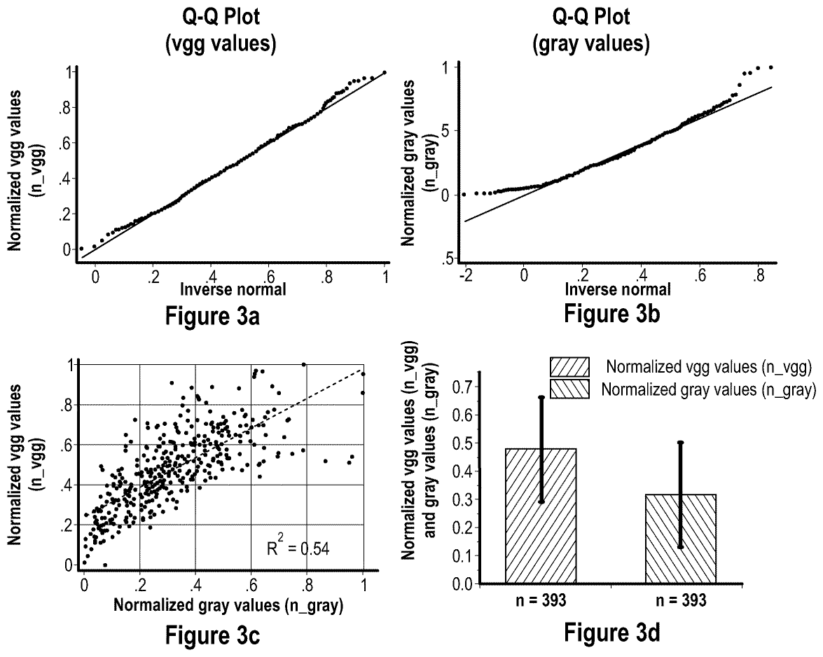

The exemplary systems, methods and computer-accessible medium according to the exemplary embodiments of the present disclosure can normalize the values using the minimum and maximum values among each class to bring them between 0 and 1. Normalized vgg (n_vgg) and grayscale (n_gray) values can be used in exemplary embodiments to plot quantile-quantile (Q-Q) plots to check whether the values follow a normal distribution. The exemplary plots in FIG. 3(a) illustrate that n_vgg values (n=393) can follow a normal distribution as the points fall approximately along the straight line. However, n_gray values (n=393) may not follow a normal distribution as seen in the exemplary plots of FIG. 3(b). With the exemplary systems, methods and computer-accessible medium according to the exemplary embodiments of the present disclosure, the criterion can also be tested using skewness-kurtosis in STATA statistical package and can yield consistent results.

With the exemplary systems, methods and computer-accessible medium according to the exemplary embodiments of the present disclosure, this may be attributed to the data being complex and the characteristics of the computations being completely different. Grayscale values, representing an image processing technique, may not conform to a normal distribution despite the Bio-FPs exhibiting normal distribution as confirmed by the DL-based vgg values. This emphasizes the efficacy of DL-based techniques of the exemplary systems, methods and computer-accessible medium according to the exemplary embodiments of the present disclosure, for image analysis-based authentication. Therefore, the exemplary embodiments of the present disclosure can select a DL-based authentication for Bio-FPs.

With the exemplary systems, methods and computer-accessible medium according to the exemplary embodiments of the present disclosure, a scatter plot and linear fit can be used to estimate the correlation and can show a 54% (R-square value) relationship between n_vgg and n_gray values, as illustrated in exemplary FIG. 3(c). To measure the relative variability of the dataset, the exemplary systems, methods and computer-accessible medium according to the exemplary embodiments of the present disclosure can calculate or otherwise determine the coefficient of variation (CV) for Bio-FPs. The CVs for n_vgg and n_gray can be 40% (mean=0.477, standard deviation=0.186) and 59% (mean=0.317, standard deviation =0.187), respectively, as illustrated in exemplary FIG. 3(d). According to the exemplary embodiments of the present disclosure, the high CV values in Bio-FPs confirm their stochastic nature.

### Exemplary Deep Learning-Based Defense Using Bio-FP

As described herein, the exemplary systems, methods and computer-accessible medium according to the exemplary embodiments of the present disclosure can focus on the DL-based approach for Bio-FP classification. The exemplary systems, methods and computer-accessible medium according to the exemplary embodiments of the present disclosure can begin by addressing the data acquisition and preprocessing techniques employed. Subsequently, the exemplary systems, methods and computer-accessible medium according to the exemplary embodiments of the present disclosure can delve into the description of the classification methods utilized. The exemplary embodiments can include the implementation of transfer learning and the specific experimental settings employed to achieve optimal results. Further, the exemplary systems, methods and computer-accessible medium according to the exemplary embodiments of the present disclosure can showcase the evaluation results of the models and conduct a comparative analysis of the performance exhibited by five different DL models.

### Exemplary Data Preprocessing

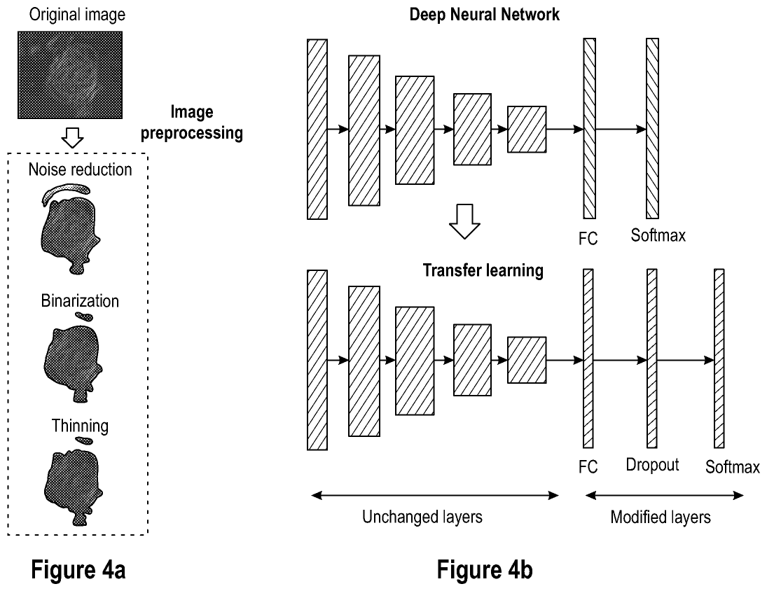

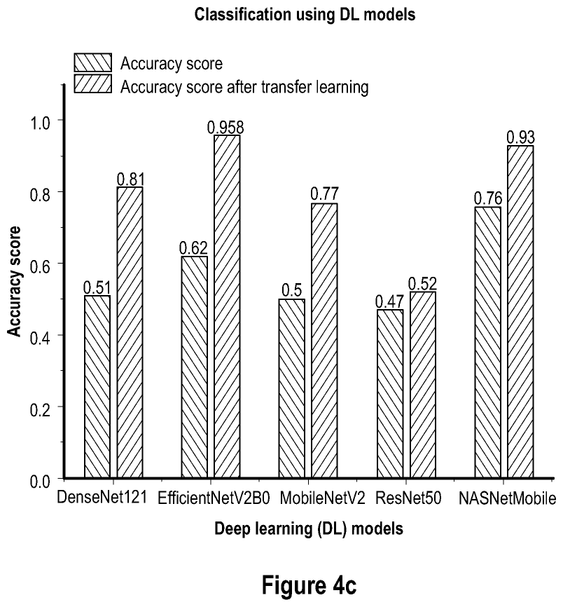

With the exemplary systems, methods and computer-accessible medium according to the exemplary embodiments of the present disclosure, data preprocessing is an important step due to the inadequate quality of the original data, which can be affected by noise. The noise, originating from various sources such as image acquisition or transmission artifacts, can lead to distortions and inconsistencies in the images. This can make it difficult for the systems, methods and computer-accessible medium according to the exemplary embodiments of the present disclosure to extract meaningful features and patterns necessary for accurate classification, resulting in the need for noise reduction. To enhance the quality of the images and ensure reliable analysis, the exemplary systems, methods and computer-accessible medium according to the exemplary embodiments of the present disclosure can employ techniques such as binarization and thinning. FIG. 4(a) illustrates an exemplary approach according to the exemplary embodiments of the present disclosure which encompasses data acquisition and preprocessing steps involving noise reduction, binarization, and thinning techniques.
1) Noise Reduction: Exemplary systems, methods and computer-accessible medium according to the exemplary embodiments of the present disclosure can remove the background of all images enabling exemplary embodiments to eliminate the noise in the background due to differences in the microscope settings for the real and counterfeit images, such as the direction of the light and distance, affecting the thickness of the fingerprint curves and backgrounds. After denoising, the exemplary systems, methods and computer-accessible medium according to the exemplary embodiments of the present disclosure may be left with the fingerprints.
2) Binarization: The exemplary systems, methods and computer-accessible medium according to the exemplary embodiments of the present disclosure can transform a dataset into binary images with red and blue colors. This facilitates the exemplary embodiments of the present disclosure to augment the initial dataset and simplify the data representation, allowing analysis of the pattern and features in the images.
3) Thinning: The exemplary systems, methods and computer-accessible medium according to the exemplary embodiments of the present disclosure can use thinning to increase a dataset and enhance the features of the fingerprint. Thinning, according to exemplary embodiments, can enhance the clarity of images by transforming the binary regions into lines that look like the skeletons of those regions.

### Exemplary DL-Based Classification

The exemplary systems, methods and computer-accessible medium according to the exemplary embodiments of the present disclosure can assess the performance of five DL-based classifiers on the Bio-FP dataset. This robust evaluation process can help with understanding of the advantages and constraints of each model.
1) DenseNet121: is a convolutional network where each layer is connected to every preceding layer, essentially receiving “collective knowledge”. It shares its feature maps with all subsequent layers via concatenation.
2) MobileNetV2: uses depth-wise separable convolutions. This exemplary process comprises a depth-wise convolution followed sequentially by a point-wise convolution.
3) ResNet 50: has 50 layers and uses residual learning, with shortcuts that facilitate information exchange. This mitigates performance degradation in deep networks and allows the network to learn complex features and deeper representations, enhancing image classification accuracy.
4) EfficientNetV2B0: balances accuracy with computational efficiency. It can employ, e.g., compound scaling, efficient block design, and stochastic depth.
5) NASNetMobile: is designed for image classification on mobile devices with limited computational resources. It uses neural architecture search to identify network architectures for specific tasks and uses depth-wise separable convolutions, repeated cells, and efficient model scaling.

### Exemplary Transfer Learning Improves DL-Based Classifiers

Transfer Learning (see, e.g., Ref. 11) facilitates the exemplary systems, methods and computer-accessible medium according to the exemplary embodiments of the present disclosure to capitalize on the knowledge from a related classification task to improve the performance of DL models of the exemplary embodiments. By using pre-trained models trained on the ImageNet (see, e.g., Ref. 12), the exemplary systems, methods and computer-accessible medium according to the exemplary embodiments of the present disclosure can reap several benefits. First, transfer learning can reduce the time and data needed for training, as exemplary systems, methods and computer-accessible medium can start from a point where the models have learned valuable features. Moreover, it can generalize the exemplary models of the exemplary embodiments of the present disclosure to new, unseen data, facilitating them to perform well even in scenarios with limited labeled data. Further, pre-trained models of the exemplary systems, methods and computer-accessible medium according to the exemplary embodiments of the present disclosure can tap into the complex representations that they learn from the ImageNet dataset. Using ImageNet for pre-training classifiers offers a basis for transfer learning. The exemplary systems, methods and computer-accessible medium according to the exemplary embodiments of the present disclosure can capitalize on the rich/diverse knowledge learned by the models.

As shown in FIG. 4(b), an exemplary DL classifier using transfer learning can be used to classify authentic and fake Bio-FPs. The exemplary systems, methods and computer-accessible medium according to the exemplary embodiments of the present disclosure can evaluate the effectiveness of transfer learning using pre-trained DL models trained on ImageNet. Most or all pre-trained layers can be made adjustable, with the output of the final layer extracted and saved. For classification purposes, the exemplary model can be enhanced with dropout regularization (e.g., dropout rate of 0.8) and incorporate softmax layers as activation functions. Model parameters used by the exemplary systems, methods and computer-accessible medium according to the exemplary embodiments of the present disclosure can be optimized to minimize classification error using categorical cross-entropy loss as the objective during training. The optimization procedure chosen for updating the model's weights can be Adam's optimizer, which may utilize a learning rate of 0.0001. The bio-FP dataset, which has labeled fingerprint images, can be employed for training and validation according to the exemplary embodiments of the present disclosure.

To assess the performance and generalizability of the model according to the exemplary embodiments, the dataset can undergo an 80-20 split, where 80% of the data may be allocated for training and the remaining 20% for validation. During training, a batch size of 50 may be employed for each iteration. Early stopping can be incorporated into implementation, according to the exemplary embodiments of the present disclosure, to detect the optimal stage during training where performance on the validation set exhibits deterioration or plateaus, indicating the emergence of overfitting. Criteria for early stopping according to the exemplary embodiments can be based on a training accuracy reaching a maximum of about 98%, ensuring that the model does not overly specialize in the training data.

### Exemplary Experimental Results on DL-Based Bio-FP Classification

Exemplary systems, methods and computer-accessible medium according to the exemplary embodiments of the present disclosure can evaluate the trained models using a distinct validation dataset. The exemplary systems, methods and computer-accessible medium according to the exemplary embodiments of the present disclosure can analyze the results of transfer learning with pre-trained models alongside baseline DL models. The exemplary results are presented in FIG. 4(c), showcasing the performance of the DL models on the validation dataset. According to the exemplary embodiments, transfer learning can improve accuracy. EfficientNetV2B0 and NASNetMobile models had the highest accuracy scores of 95.8% and 93% respectively. Besides highlighting the effectiveness of transfer learning in improving performance, the results showcase the potential for more accuracy through pre-trained models.

With the exemplary systems, methods and computer-accessible medium according to the exemplary embodiments of the present disclosure, DenseNet121, MobileNetV2, and ResNet50 may not yield good results compared to the models that underwent transfer learning. DenseNet121 may have 81% accuracy. MobileNetV2 and ResNet50 may have lower accuracy. There could be many reasons behind this decrease. It is likely pre-trained weights of the models are not well-suited to exemplary embodiments, or the target dataset had characteristics that differed from the ImageNet on which these models were originally trained. Hence, the models struggled to adapt and learn meaningful representations for classification according to exemplary embodiments. The proficient compound scaling ability of EfficientNetV2B0 allowed it to capture intricate patterns and features present in the data, resulting in its exceptional performance in exemplary embodiments of the present disclosure. Similarly, NASNetMobile, designed with an architecture derived from reinforcement learning, can demonstrate the capacity to explore an extensive search space and achieve optimal outcomes. In contrast, while DenseNet121, MobileNetV2, and ResNet50 are widely recognized and widely employed models, they may exhibit limitations in terms of depth, network connectivity, or architectural design, which can contribute to their relatively lower performance when compared to EfficientNetV2B0 and NASNetMobile.

### Exemplary DL-Based Authentication of Bio-FPs

The exemplary systems, methods and computer-accessible medium according to the exemplary embodiments of the present disclosure can describe the proposed DL-based Bio-FP authentication scheme, designed to distinguish between authentic and counterfeit fingerprints using a DL classifier. This supervised classification approach can address an adversary's attempt to misclassify an i-th class fingerprint as a j-th class by creating a near-identical fingerprint and adding noise to mask imperfections, thereby aiming to deceive the authentication system. For DL training, the exemplary systems, methods and computer-accessible medium according to the exemplary embodiments of the present disclosure can printed authentic Bio-FPs at 8 kV (e.g., 772), along with counterfeit samples at 6 kV, 7 kV, 9 kV, and 10 kV (e.g., 122, 110, 101, and 108, respectively). The exemplary systems, methods and computer-accessible medium according to the exemplary embodiments of the present disclosure can analyze the uniqueness of Bio-FPs as follows.
1. A supervised binary classification can be performed between authentic and counterfeit fingerprints. The counterfeit fingerprints can be generated by varying the voltage parameter from 8 kV to 6 kV, 7 kV, 9 kV, and 10 kV. This can justify the singularity of fingerprints created with authentic parameters.
2. Next, the exemplary systems, methods and computer-accessible medium according to the exemplary embodiments of the present disclosure can combine various classes of counterfeit fingerprints and retrain the DL models using both authentic and mixed counterfeit Bio-FPs. After training, the exemplary systems, methods and computer-accessible medium according to the exemplary embodiments of the present disclosure can evaluate the models' performance on a separate, unseen set of counterfeit fingerprints.

The exemplary systems, methods and computer-accessible medium according to the exemplary embodiments of the present disclosure can begin with data preprocessing, followed by classifier design using transfer learning. Further, the exemplary systems, methods and computer-accessible medium according to the exemplary embodiments of the present disclosure can showcase the model results and compare the performance of the DL models.

### Exemplary Data Processing

Noise from sources such as acquisition or transmission artifacts can distort and create inconsistencies in the fingerprint data, making it challenging to extract meaningful features and patterns for accurate classification. The exemplary systems, methods and computer-accessible medium according to the exemplary embodiments of the present disclosure can address this challenge by performing noise reduction, normalization, resizing, and histogram equalization to enhance data quality. Additionally, the exemplary systems, methods and computer-accessible medium according to the exemplary embodiments of the present disclosure can apply data augmentation to expand the dataset for analyzing the uniqueness of Bio-FPs.
Noise Reduction: The exemplary systems, methods and computer-accessible medium according to the exemplary embodiments of the present disclosure can remove background noise caused by variations in microscope settings between authentic and counterfeit samples. Using the remove module from the open-source Python library rembg, the exemplary systems, methods and computer-accessible medium according to the exemplary embodiments of the present disclosure can eliminate background noise effectively.
Resize or Crop: The exemplary systems, methods and computer-accessible medium according to the exemplary embodiments of the present disclosure can also resize or crop the data to a standard size, ensuring consistent pixel counts across samples. The exemplary systems, methods and computer-accessible medium according to the exemplary embodiments of the present disclosure can match the dimensions of the ImageNet dataset, 224×224×3, to maintain compatibility.
Normalization: Exemplary systems, methods and computer-accessible medium according to the exemplary embodiments of the present disclosure can scale each data point's pixel values to the [0, 1] range, preventing differences in intensity scales from affecting correlation calculations. Normalization can be achieved by dividing pixel values by 255, given the original intensity range of 0-255.
Histogram Equalization: This technique, employed by the exemplary systems, methods and computer-accessible medium according to the exemplary embodiments of the present disclosure, can adjust each sample's histogram to improve contrast and standardize brightness levels. The exemplary systems, methods and computer-accessible medium according to the exemplary embodiments of the present disclosure can use the equalizeHist module from OpenCV for this enhancement.
Data Augmentation: Exemplary systems, methods and computer-accessible medium according to the exemplary embodiments of the present disclosure can apply the Augmentor library to perform data augmentation, using techniques such as rotation, random zoom, and horizontal and vertical flips. Specifically, each sample can be randomly rotated up to 10 degrees with a 70% probability, zoomed in with a 50% probability, and flipped horizontally and vertically, also with a 50% probability.

### Exemplary DL-Based Classifiers

The exemplary systems, methods and computer-accessible medium according to the exemplary embodiments of the present disclosure can consider four DL-based classifiers and assess their performance on the Bio-FP dataset. To evaluate the performance of the DL models on the dataset, the exemplary systems, methods and computer-accessible medium according to the exemplary embodiments of the present disclosure can consider five metrics: accuracy, precision, recall, F1-score, and area under the receiver operating characteristics curve (AUC-ROC). This assist with the understanding the advantages and limitations of each model. A brief introduction to the exemplary DL models is provided below.
DenseNet-121: DenseNet-121 is a convolutional neural network where each layer is connected to every preceding layer, essentially receiving “collective knowledge.” It shares its feature maps with all subsequent layers via concatenation.
Inception-V3: The Inception-V3 architecture uses inception modules that incorporate multiple convolutional layers with diverse kernel sizes and pooling operations, allowing the network to capture features across scales and resolutions.
VGG-19: VGG-19 is a convolutional neural network architecture characterized by its deep structure, consisting of 19 layers, including convolutional layers, max-pooling layers, and fully connected layers.
Xception: Xception, derived from “Extreme Inception,” represents an advancement of the Inception architecture. This model is characterized by its depthwise separable convolutions, which efficiently separate the spatial and channel-wise dimensions of the input data.

### Exemplary Implementation of the DL-Based Classifiers

Transfer learning facilitates the exemplary systems, methods and computer-accessible medium according to the exemplary embodiments of the present disclosure to capitalize on a related classification task to improve the performance of the DL models. The exemplary systems, methods and computer-accessible medium according to the exemplary embodiments of the present disclosure can pre-train the models on the ImageNet dataset, modifying the top layers to cater to the specific dataset. This process is detailed below.

Classifying Real and Counterfeit Bio-FPs by Adapting Voltage: This dataset consists of five different classes of fingerprints generated by adjusting the voltage parameter from 8 kV to 6 kV, 7 kV, 9 kV, and 10 kV, where 8 kV is the voltage used for authentic fingerprints. Counterfeit fingerprints, however, can be generated by adapting the voltage to any other finite value. The exemplary systems, methods and computer-accessible medium according to the exemplary embodiments of the present disclosure can evaluate the effectiveness of transfer learning by using pre-trained DL models trained on ImageNet, incorporating the global average pooling (GAP) layer on top of the pre-trained models, instead of a flatten layer. The flatten layer reshapes the entire output volume into a single long vector, which is more effective in object detection or segmentation tasks. In contrast, the GAP layer calculates the mean value of each feature map, preserving the extracted features and facilitating classification. Both layers serve as methods to transform the output volume of a CNN before feeding it into a fully connected (FC) layer.

This can be followed by three FC layers with 256, 128, and 64 neurons, each employing the rectified linear unit (ReLU) activation function. ReLU enhances model learning by enabling the network to capture complex relationships or non-linearity within the data. The final FC layer, with 64 neurons, incorporates an additional L1 or Lasso regularizer (0.0001). For the exemplary classification, the exemplary systems, methods and computer-accessible medium according to the exemplary embodiments of the present disclosure can further enhance the model with dropout regularization (dropout rate of 0.5) and incorporate the sigmoid layer as the activation function, commonly used for binary classification. The dropout layer randomly drops neurons from the previous layer to prevent overfitting, while the regularization parameter penalizes large weights, discouraging overly complex models. Together, regularization and dropout prevent the models from overfitting, yielding a more generalized classification of Bio-FP instances.

The exemplary systems, methods and computer-accessible medium according to the exemplary embodiments of the present disclosure can use the binary cross-entropy loss function to optimize the model parameters and reduce classification error. The Adam optimizer updates the model's weights, using a learning rate of 1e-5 for the 8 kV vs. 6 kV classification and 1e-4 for the remaining classifications.

With the exemplary systems, methods and computer-accessible medium according to the exemplary embodiments of the present disclosure, the pre-trained CNN models can be fed with the labeled Bio-FP dataset for training and validation purposes. To assess the model's performance and generalizability, the exemplary systems, methods and computer-accessible medium according to the exemplary embodiments of the present disclosure can split the dataset into 80% training and 20% validation subsets. For the original dataset, with a data distribution as provided in Table II, the batch size can be set to 16, allowing for more frequent parameter updates and promoting better generalization. For the augmented dataset, containing 4,457 images in each class, the batch size can be set to 32. The corresponding epochs, or training iterations, can be set to 100 and 200, respectively.

### Exemplary Simulation Results for DL-Based Authentication of Bio-FPs

First, the exemplary systems, methods and computer-accessible medium according to the exemplary embodiments of the present disclosure can perform binary classification to differentiate between authentic and counterfeit fingerprints, training the DenseNet-121 model on a labeled dataset. With the original, unaugmented dataset of 1,213 fingerprints, the model achieved high validation accuracy across voltage comparisons, with 95% accuracy for, e.g., 8 kV vs. 6 kV, 98.2% for 8 kV vs. 7 kV and 9 kV, and 97.5% for 8 kV vs. 10 kV. Adding dropout regularization helped reduce overfitting and slightly improved model generalization.

Next, the exemplary systems, methods and computer-accessible medium according to the exemplary embodiments of the present disclosure can expand the dataset through data augmentation to address sparsity and imbalance, creating 4,457 fingerprints for each class. The exemplary systems, methods and computer-accessible medium according to the exemplary embodiments of the present disclosure can train four distinct CNN architectures—DenseNet-121, Inception-V3, VGG-19, and Xception—on this augmented dataset for 200 epochs. The exemplary results demonstrate a noticeable improvement in classification performance for all models. Specifically, VGG-19 consistently achieved the highest validation accuracies (e.g., 99.83% for 8 kV vs. 6 kV and 7 kV, 99.94% for 8 kV vs. 9 kV, and 99.81% for 8 kV vs. 10 kV). DenseNet-121 also performed closely, achieving approximately 99% accuracy across comparisons, followed by Inception-V3 and Xception with slightly lower, yet still high accuracies.

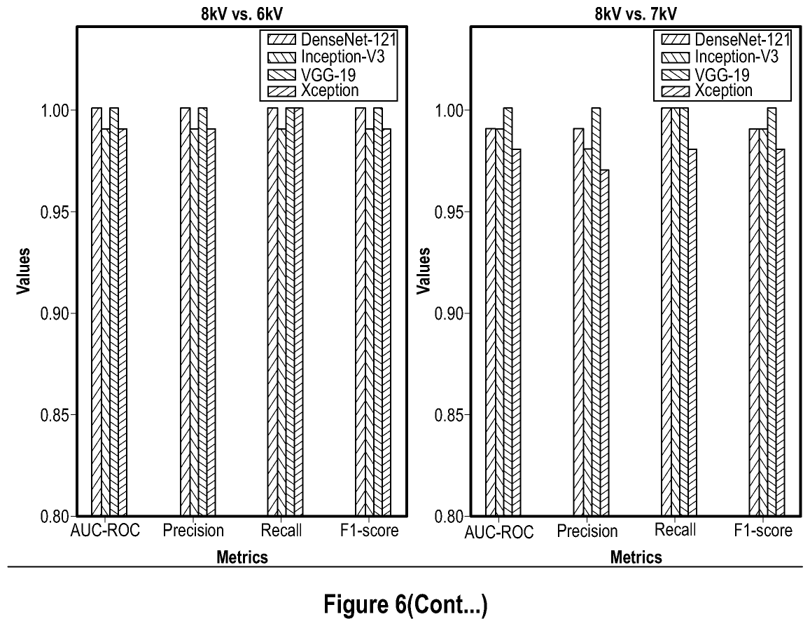

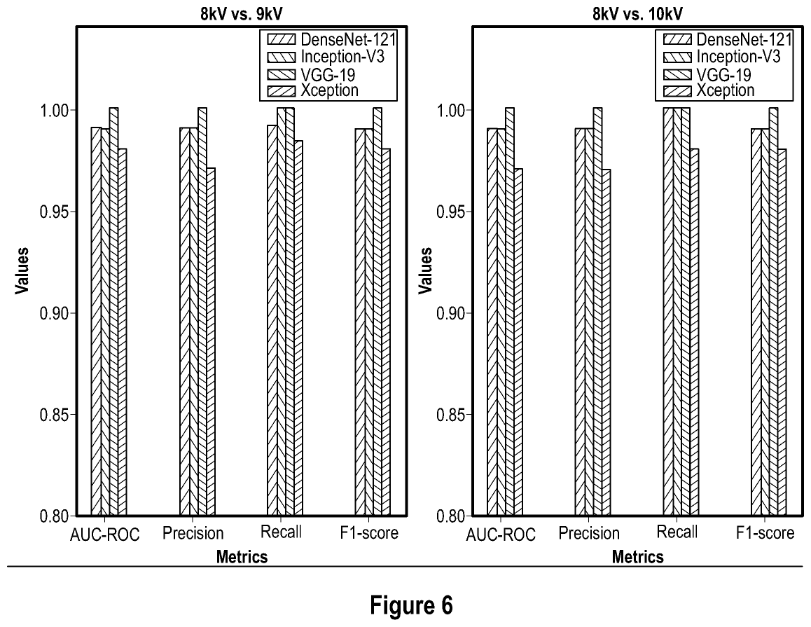

FIG. 6 illustrates the exemplary performance metrics for each model in terms of accuracy, precision, recall, F1-score, and AUC-ROC across all voltage comparisons. Overall, VGG-19 exhibited near-ideal classification metrics, outperforming the other architectures. This enhanced training on the augmented dataset allowed each model to approximate an ideal classifier, validating the robustness of the DL-based approach in distinguishing between authentic and counterfeit Bio-FPs.

The exemplary systems, methods and computer-accessible medium according to the exemplary embodiments of the present disclosure can conduct DL-based authentication analyses using various deep learning models and multiple image-enhancement preprocessing techniques. By applying transfer learning and fine-tuning with different models, the exemplary systems, methods and computer-accessible medium according to the exemplary embodiments of the present disclosure can achieve a maximum Bio-FP classification accuracy of 99.94%. This proposed countermeasure offers a robust authentication scheme to protect these security-critical biochips against IP theft threats.

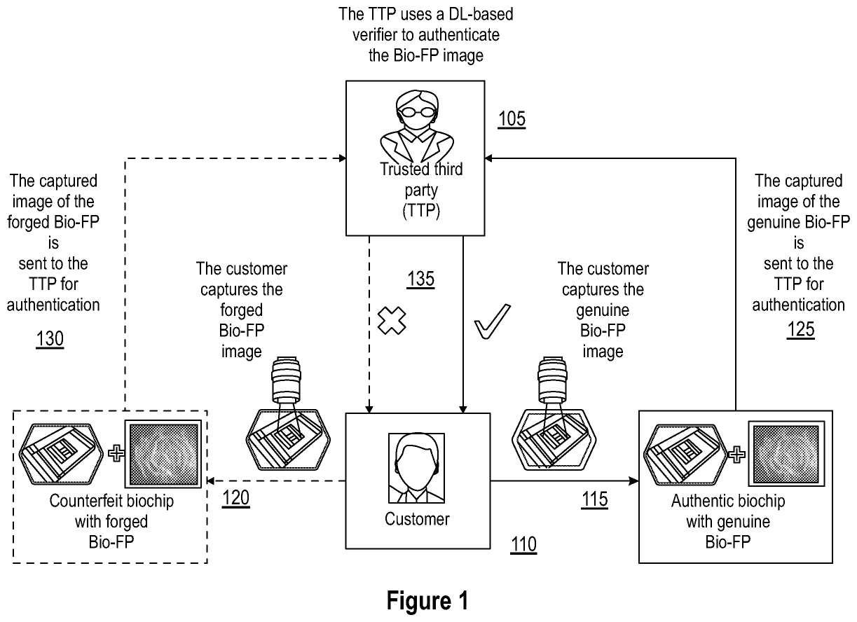

FIG. 1 illustrates an exemplary threat model associated with biochip fingerprints (Bio-FP), where the Trusted Third Party (TTP) 105 preferably authenticates a genuine Bio-FP (solid lines) and rejects a forged one (dashed lines) using a deep learning (DL)-based verifier. The exemplary process includes Customer 110 capturing a Bio-FP image—either genuine 115, or forged 120. Next, the captured image is sent to the TTP, which in the case of an authentic Bio-FP, occurs at 125, and in the case of a counterfeit Bio-FP, occurs at 130. The TTP 105 then uses a DL-based verifier to determine the authenticity of the provided image. If the Bio-FP is authenticated, then at 135, the TPP returns a positive authentication to the Customer 110. However, if the image is not authenticated by the TTP, then a negative authentication is returned by the TTP at 135. The biochip system forms a triad among a Bio-FP-embedded biochip, the customer, and the TTP, which validates the biochip's provenance. Customers 110—including research institutions, forensic labs, pharmaceutical and biotech firms, clinical diagnostic centers, hospitals, and healthcare services—rely on this verification process. However, if the fingerprinting technique underlying the DL-based verifier is replicable, attackers may exploit this vulnerability to introduce counterfeit or overbuilt biochips into the supply chain. Existing methods, such as barcodes, QR codes, radio-frequency identification (RFID) tags, depth holograms, and taggants, are often replicable and susceptible to tampering. This highlights the need for a low-cost, nondestructive technology that allows for real-time biochip authentication without specialized expertise.

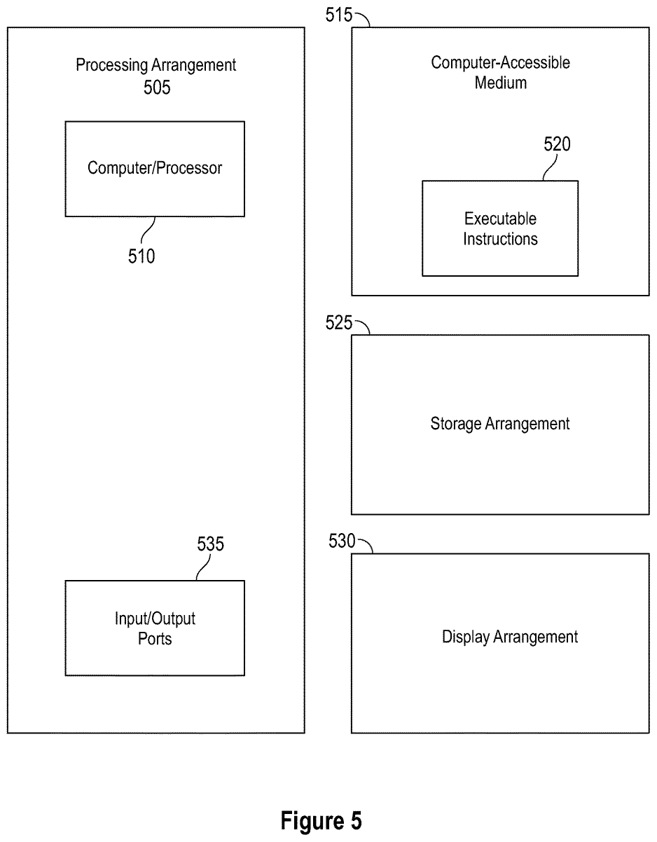

FIG. 5 shows a block diagram of an exemplary embodiment of a system according to the present disclosure. For example, the exemplary procedures in accordance with the present disclosure described herein can be performed by a processing arrangement and/or a computing arrangement (e.g., computer hardware arrangement) 505. Such processing/computing arrangement 505 can be, for example entirely or a part of, or include, but not limited to, a computer/processor 510 that can include, for example one or more microprocessors, and use instructions stored on a computer-accessible medium (e.g., RAM, ROM, hard drive, or other storage device).

As shown in FIG. 5, for example a computer-accessible medium 515 (e.g., as described herein above, a storage device such as a hard disk, floppy disk, memory stick, CD-ROM, RAM, ROM, etc., or a collection thereof) can be provided (e.g., in communication with the processing arrangement 505). The computer-accessible medium 515 can contain executable instructions 520 thereon. In addition, or alternatively, a storage arrangement 525 can be provided separately from the computer-accessible medium 515, which can provide the instructions to the processing arrangement 505 so as to configure the processing arrangement to execute certain exemplary procedures, processes, and methods, as described herein above, for example.

Further, the exemplary processing arrangement 505 can be provided with or include an input/output ports 535, which can include, for example a wired network, a wireless network, the internet, an intranet, a data collection probe, a sensor, etc. As shown in FIG. 5, the exemplary processing arrangement 505 can be in communication with an exemplary display arrangement 530, which, according to certain exemplary embodiments of the present disclosure, can be a touch-screen configured for inputting information to the processing arrangement in addition to outputting information from the processing arrangement, for example. Further, the exemplary display arrangement 530 and/or a storage arrangement 525 can be used to display and/or store data in a user-accessible format and/or user-readable format.

### Exemplary Conclusion

The exemplary systems, methods and computer-accessible medium according to the exemplary embodiments of the present disclosure can provide biochip-fingerprints (Bio-FP) authentication schemes, which operate at the biochip level. The exemplary embodiments can print unique fingerprints on biochips using a 3D printer and enhance security by applying an invisible layer of PDMS. The fingerprints, according to the exemplary embodiments of the present disclosure, can be detected using UV light and undergo spectral analysis for enhanced authentication. By employing data preprocessing and deep learning techniques, including image denoising and transfer learning, the exemplary systems, methods and computer-accessible medium according to the exemplary embodiments of the present disclosure can achieve authentication accuracy of up to or around 95.8%. The Bio-FP scheme of exemplary embodiments can offer proactive protection against IP-theft attacks.

According to the exemplary embodiments of the present disclosure, numerous specific details have been set forth. It is to be understood, however, that implementations of the disclosed technology can be practiced without these specific details. In other instances, well-known methods, structures and techniques have not been shown in detail in order not to obscure an understanding of this description. References to “some examples,” “other examples,” “one example,” “an example,” “various examples,” “one embodiment,” “an embodiment,” “some embodiments,” “example embodiment,” “various embodiments,” “one implementation,” “an implementation,” “example implementation,” “various implementations,” “some implementations,” etc., indicate that the implementation(s) of the disclosed technology so described may include a particular feature, structure, or characteristic, but not every implementation necessarily includes the particular feature, structure, or characteristic. Further, repeated use of the phrases “in one example,” “in one exemplary embodiment,” or “in one implementation” does not necessarily refer to the same example, the exemplary embodiment, or implementation, although it may.

As used herein, unless otherwise specified the use of the ordinal adjectives “first,” “second,” “third,” etc., to describe a common object, merely indicate that different instances of like objects are being referred to, and are not intended to imply that the objects so described must be in a given sequence, either temporally, spatially, in ranking, or in any other manner.

While certain implementations of the disclosed technology have been described in connection with what is presently considered to be the most practical and various implementations, it is to be understood that the disclosed technology is not to be limited to the disclosed implementations, but on the contrary, is intended to cover various modifications and equivalent arrangements included within the scope of the appended claims. Although specific terms are employed herein, they are used in a generic and descriptive sense only and not for purposes of limitation.

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements, and procedures which, although not explicitly shown or described herein, embody the principles of the disclosure and can be thus within the spirit and scope of the disclosure. Various different exemplary embodiments can be used together with one another, as well as interchangeably therewith, as should be understood by those having ordinary skill in the art. In addition, certain terms used in the present disclosure, including the specification and drawings, can be used synonymously in certain instances, including, but not limited to, for example, data and information. It should be understood that, while these words, and/or other words that can be synonymous to one another, can be used synonymously herein, that there can be instances when such words can be intended to not be used synonymously. Further, to the extent that the prior art knowledge has not been explicitly incorporated by reference herein above, it is explicitly incorporated herein in its entirety. All publications referenced are incorporated herein by reference in their entireties.

Throughout the disclosure, the following terms take at least the meanings explicitly associated herein, unless the context clearly dictates otherwise. The term “or” is intended to mean an inclusive “or.” Further, the terms “a,” “an,” and “the” are intended to mean one or more unless specified otherwise or clear from the context to be directed to a singular form.

This written description uses examples to disclose certain implementations of the disclosed technology, including the best mode, and also to enable any person skilled in the art to practice certain implementations of the disclosed technology, including making and using any devices or systems and performing any incorporated methods.

### EXEMPLARY REFERENCES

The following references are hereby incorporated by reference, in their entireties:
1. N. S. Baban, J. Zhou, K. Elkhoury, S. Bhattacharjee, S. Vijayavenkatara-man, N. Gupta, Y.-A. Song, K. Chakrabarty, and R. Karri, “Biotrojans: viscoelastic microvalve-based attacks in flow-based microfluidic biochips and their countermeasures,” Scientific Reports, vol. 14, no. 1, p. 19806, 2024.
2. N. S. Baban, S. Saha, A. Orozaliev, J. Kim, S. Bhattacharjee, Y. Song, R. Karri, and K. Chakrabarty, “Structural attacks and defenses for flow-based microfluidic biochips,” IEEE Transactions on Biomedical Circuits and Systems., vol. 16, no. 6, pp. 1261-1275, 2022.
3. N. S. Baban, S. Saha, S. Jancheska, I. Singh, S. Khapli, M. Khobdabayev, J. Kim, S. Bhattacharjee, Y.-A. Song, K. Chakrabarty, and S. Bhattacharjee, “Material-level countermeasures for securing microfluidic biochips,” Lab on a Chip, vol. 23, no. 19, pp. 4213-4231, 2023.
4. M. Intelligence, “Biochip market size & share analysis-growth trends & forecasts (2024-2029),” 2023. [Online]. Available: https://www.mordorintelligence.com/industry-reports/biochip-product-market
5. “Fake COVID-19 kits seized in international trafficking crackdown from 77 countries,” July 2020. [Online]. Available: https://www.ndtv.com/world-news/coronavirus-fake-covid-19-kits-seized-in-international-trafficking-crackdown-from-77-countries-2267147
6. S. S. Ali, M. Ibrahim, J. Rajendran, O. Sinanoglu, and K. Chakrabarty, “Supply-chain security of digital microfluidic biochips,” Computer, vol. 49, no. 8, pp. 36-43, 2016.
7. M. Shayan, S. Bhattacharjee, A. Orozaliev, Y.-A. Song, K. Chakrabarty, and R. Karri, “Thwarting bio-ip theft through dummy-valve-based obfuscation,” IEEE Transactions on Information Forensics and Security, vol. 16, pp. 2076-2089, 2020.
8. T.-C. Liang, K. Chakrabarty, T. Abaffy, H. Matsunami, and R. Karri, “Securing biochemical samples using molecular barcoding on digital microfluidic biochips,” in 2021 IEEE Biomedical Circuits and Systems Conference (BioCAS). IEEE, 2021, pp. 01-06.
9. N. S. Baban, “Bio-FP video using a melt-electrospinning 3D printer,” Online on Youtube, June 2023, available: https://youtube/-643gDvnN5M [Accessed on 2023-06-01].
10. K. Simonyan and A. Zisserman, “Very deep convolutional networks for large-scale image recognition,” arXiv preprint arXiv: 1409.1556, 2014.
11. S. J. Pan and Q. Yang, “A survey on transfer learning,” IEEE Transactions on Knowledge and Data Engineering, vol. 22, no. 10, pp. 1345-1359, 2009.
12. J. Deng, W. Dong, R. Socher, L.-J. Li, K. Li, and L. Fei-Fei, “Imagenet: A large-scale hierarchical image database,” 2009 IEEE Conference on Computer Vision and Pattern recognition, pp. 248-255, 2009.

What is claimed is:

1. A method for printing a fingerprint, comprising:
applying, via a melt electrospinning three-dimensional (3D) printer, a filament to a substrate, the filament interacting stochastically with the substrate due to attraction to one or more electrodes.

2. The method of claim 1, further comprising applying an elastomer (i) to the substrate, and (ii) over the applied filament.

3. The method of claim 2, wherein the elastomer is a thermoplastic polymer.

4. The method of claim 3, wherein the thermoplastic polymer is at least one of polycaprolactone or polydimethylsiloxane.

5. The method of claim 1, wherein the filament includes an ultra-violet dye.

6. The method of claim 1, wherein the filament is doped with one or more quantum dots.

7. The method of claim 1, wherein the attraction to the one or more electrodes is the result of an application of an electric field.

8. The method of claim 1, wherein the 3D printer applies the filament in a defined pattern.

9. The method of claim 1, wherein the 3D printer operates under a defined set of print conditions.

10. The method of claim 9, wherein the defined set of print conditions comprise a temperature of 85° C., a distance of 6 mm between a printer nozzle and the substrate, and a 0.125 MPa dispensing pressure.

11. The method of claim 7, wherein the electric field is 8.0 kV.

12. A system for printing a fingerprint, comprising:
a melt electrospinning three-dimensional (3D) printer configured to apply a filament to a substrate, said filament interacting stochastically with the substrate due to attraction to one or more electrodes.

13. The system of claim 12, further comprising a spin coater configured to uniformly apply an elastomer to the substrate over the applied filament.

14. The system of claim 13, wherein the elastomer is a thermoplastic polymer.

15. The system of claim 14, wherein the thermoplastic polymer is at least one of polycaprolactone or polydimethylsiloxane.

16. The system of claim 12, wherein the filament includes an ultra-violet dye.

17. The system of claim 12, wherein the filament is doped with one or more quantum dots.

18. The system of claim 12, wherein the attraction to the one or more electrodes is the result of an application of an electric field.

19. The system of claim 12, wherein the 3D printer applies the filament in a defined pattern.

20. The system of claim 12, wherein the 3D printer operates under a defined set of print conditions.

21. The system of claim 20, wherein the defined set of print conditions comprise a temperature of 85° C., a distance of 6 mm between a printer nozzle and the substrate, and a 0.125 MPa dispensing pressure.

22. The system of claim 18, wherein the electric field is 8.0 kV.
